(19) United States
(12) Patent Application Publication
(10) Pub. No.: US 2003/0097441 A1
(43) Pub. Date: May 22, 2003

(54) System and method for controlling information delivery procedures using physical entities

(76) Inventor: Shin ichi Konomi, Ohnojo-shi (JP)

Correspondence Address: THE LAW FIRM OF HARRIS & BURDICK, HAROLD BURDICK AND ROBERT HARRIS, 6676 GUNPARK DRIVE, SUITE E, BOULDER, CO, 80301

(21) Appl. No.: 10/295,149

(22) Filed: Nov. 15, 2002

(30) Foreign Application Priority Data
Nov. 16, 2001 (JP) 2001-390639

(51) Int. Cl. G06F 15/173

(52) U.S. Cl. 709/224

(57) ABSTRACT

The objective of this invention is to provide systems and methods that allow users to easily control information delivery procedures through an intuitive process using physical entities for selecting profiles and synthesizing filters.

Information delivery procedure control systems and methods are provided that use a physical entity recognition procedure for acquiring identification information of physical entities, a filter synthesis procedure for selecting profiles and synthesizing filters using said identification information, an information delivery procedure for delivering information to users according to contents of filters and a profile management procedure for managing profiles. Note that said information delivery procedure is for delivering information using information filtering, information retrieval that is supported by profile information, or information dissemination.

### CROSS-REFERENCE TO RELATED APPLICATIONS

Not applicable.

### STATEMENT REGARDING FEDERALLY SPONSORED RESEARCH OR DEVELOPMENT

This patent includes a result of the research and development that were sponsored by the Japanese government (Ministry of Economy, Trade and Industry, FY2001 IPA MITOU Software Project).

### BACKGROUND

1. Field of Invention

This invention relates to systems for delivering information including information filtering systems and information retrieval systems, specifically to systems and methods for delivering information that are able to adapt processing details to changes in situations.

2. Description of Prior Art

In recent years, distributed computers can share information via wired as well as wireless computer networks where the shared information is stored on storage systems such as file systems and database systems. The amount of information one can obtain via computer networks is enormous.

Information filtering is a means to select and deliver information that matches interests of each user from a large amount of information. Since information filtering systems can actively deliver information to users, they are called ‘push’ systems. In ‘push’ systems, it is not necessary for users to specify needed information every time using keywords etc. In information filtering systems, interests of users are generally described in advance in data structures called user profiles. The systems evaluate relevancy of given information based on user profiles and deliver users only the information that is considered to match the user profiles.

One of the most important issues of information filtering systems is to correctly determine if given information is relevant to users' interests. To correctly determine it, profiles should reflect users' interests accurately. An approach to solving this issue, which is called relevance feedback, is disclosed in unexamined JP patent application 09-153064. In relevance feedback, users determine if received information matches their own interests, give the result of determining it to the system as feedback and thereby the quality of profiles is gradually improved. Relevance feedback could be useful for maintaining the quality of profiles when, for example, characteristics of shared information and users' interests change gradually as time goes on. In addition, as disclosed in unexamined JP patent application 2001-229164, there is a system that combines multiple filter components and thereby maintains the performance of a filter when characteristics of shared information and users' interests change as time goes on.

In ‘pull’ systems, in which users need to specify information of their interests every time, profiles can be effectively utilized in a similar way as in information filtering systems. In the system that is disclosed in unexamined JP patent 2001-14332, profiles are used for information retrieval on a vehicle equipped with a terminal etc. The profiles are utilized in order to allow users to obtain needed information only by entering a small number of keywords. Said profiles are not used to make the system deliver information to users automatically, but used to support information retrieval operations performed by users. In this specification, information retrieval that is performed using profiles as support is called profile-supported information retrieval.

Also, mobile devices such as notebook computers, handheld computers, personal digital assistants (PDAs) and high functionality mobile phones are pervading in our society. Because display screens and input methods of mobile devices are limited, it is expected to be capable of effectively supporting information filtering and profile-supported information retrieval. Users of mobile devices may use systems at various places while on the move, it should be anticipated that users' interests would change abruptly according to surrounding environments. To inform systems of changes of said surrounding environments, a location information obtaining procedure involving the global positioning system (GPS), or various sensors including smart tag readers and barcode scanners can be used.

### SUMMARY

In existing information delivery technologies that use profiles, it is difficult to update profiles immediately and appropriately when characteristics of shared information and users' interests change abruptly. Therefore, there exists a problem that systems become unable to deliver appropriate information to users when such abrupt changes occur.

In existing systems, there exists a problem that users are not provided with easy and intuitive operation methods for selecting appropriate profiles and synthesizing filters. In existing systems, it requires knowledge on the systems' internal models to perform operations for selecting profiles and synthesizing filters. Therefore, it is difficult for regular as well as novice users to perform these operations.

The object of this invention, which is performed in consideration of the above respects, is to provide systems and methods that allow for selecting profiles and synthesizing filters in intuitive fashions using physical entities.

The provision of said systems and methods makes it possible to easily control information delivery systems including information filtering systems and profile-supported information retrieval systems when users' interests change abruptly, and to obtain information that matches users' new needs.

Note that the words physical entities are used in this specification to denote physical objects, humans, animals, plants, geographic locations and areas, and any other entities that have physical presence.

To solve the above problems, this invention provides information delivery procedure control systems and methods for controlling information delivery procedures by intuitive operations using physical entities.

Specifically, first, if at least one physical entity is presented to a computing device such as a mobile device or a computer, the information delivery procedure control systems use a physical entity recognition procedure for acquiring identification information of a physical entity and obtain identification information of said physical entity. Next, the information delivery procedure control systems use a filter synthesis procedure for synthesizing a filter using identification information of a physical entity and synthesize the filter that corresponds to said identification information. Said synthesized filter is used afterwards for controlling an information delivery procedure. That is, information objects selected by said stored filter are delivered to a user each time using an information delivery procedure that delivers needed information to the user according to the description of the filter. Also, the information delivery procedure control systems according to this invention have a profile management procedure for storing and managing profile information that is provided to the filter synthesis procedure.

In the information delivery procedure control systems and methods according to this invention, an information delivery procedure realizes an information filtering function, a profile-supported information retrieval function, or an information dissemination function. Furthermore, information objects can contain text, audio, image, video, and hyperlink information.

### DRAWING FIGURES

FIG. 1 illustrates an architecture of an information delivery procedure control system according to this invention;

FIG. 2 illustrates an architecture of an information delivery sub-system that realizes an information filtering function;

FIG. 3 illustrates an architecture of an information delivery sub-system that realizes an information retrieval function;

FIG. 4 illustrates a structure of a profile database;

FIG. 5 illustrates an exemplary architecture of a mobile device that users can use in information delivery procedure control systems according to this invention;

FIG. 6 illustrates an overview of a faceplate device that is an example of a physical entity used in information delivery procedure control systems according to this invention;

FIG. 7 illustrates an overview of a holder device that is an example of a physical entity used in information delivery procedure control systems according to this invention;

FIG. 8 illustrates an overview of filter cards that are examples of a physical entity used in information delivery procedure control systems according to this invention;

FIG. 9 is a flowchart outlining processing steps for synthesizing a filter using physical entities;

FIG. 10 is a flowchart outlining processing steps for controlling information filtering using the synthesized filter;

FIG. 11 is a flowchart outlining processing steps for controlling information retrieval through a text input module using the synthesized filter; and

FIG. 12 is a flowchart outlining processing steps for controlling information retrieval via a physical entity recognition module using the synthesized filter.

REFERENCE NUMBERS IN DRAWINGS

| | |
|---|---|
| 110 | information delivery sub-system |
| 120 | filter synthesis module |
| 130 | physical filter recognition module |
| 140 | profile database |
| 200 | filtering engine |
| 300 | search engine |
| 340 | physical entity recognition module |
| 600 | faceplate device |
| 700 | holder device |

### DESCRIPTION

An information delivery procedure control system, which is an embodiment of this invention, will be explained using figures.

This system allows users of information filtering systems or profile-supported information retrieval systems to automatically select profiles and synthesize filters by making a mobile device recognize certain physical objects according to need. A synthesized filter is used to support information filtering for delivering information to said users or profile-supported information retrieval performed by said users.

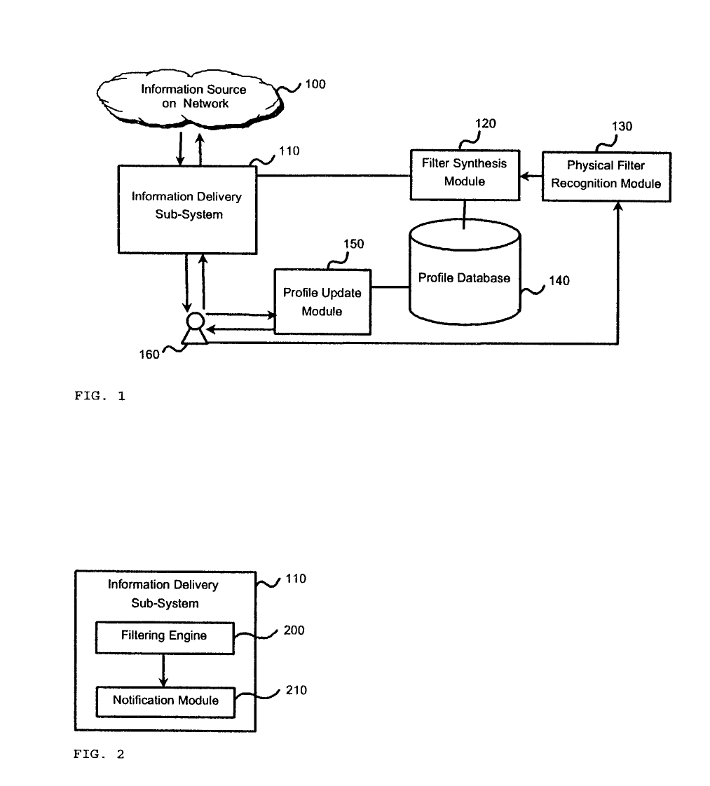

An architecture of this information delivery procedure control system is illustrated in FIG. 1. An information delivery sub-system 110 used by a user 160 is a sub-system for providing a needed function that is either a information filtering function, a profile-supported information retrieval function, or an information dissemination function. Details of sub-systems providing each function will be described later. Note that more than one users can use the information delivery sub-system 110.

The user 160 can control the operation of the information delivery procedure provided by the information delivery sub-system using physical entities such as physical objects. The user 160 presents an appropriate physical entity to a physical filter recognition module 130. The physical filter recognition module obtains the identification information of the presented physical entity using sensors including barcode scanners and radio frequency identification (RFID) readers, which are also called smart tag readers, and then sends said identification information to a filter synthesis module 120. The filter synthesis module 120 searches a profile database 140 using said identification information and synthesizes a filter based on the filter synthesis information that corresponds to said physical entity. The synthesized filter is available for the information delivery sub-system 110 to use.

The user 160 can add to, delete from and modify contents of the profile database 140 using a profile update module 150.

The information delivery procedure provided by the information delivery sub-system 110 performs tasks of acquiring needed information objects from information sources 100 on the network and delivering the acquired information objects to the user 160. In performing these tasks, a determination is made as to which object to deliver (or not to deliver) to the user 160 after referring an available filter. Therefore, the user 160 can synthesize a filter and make it available depending on situations using a physical entity and control the information delivery procedure provided by the information delivery sub-system 110.

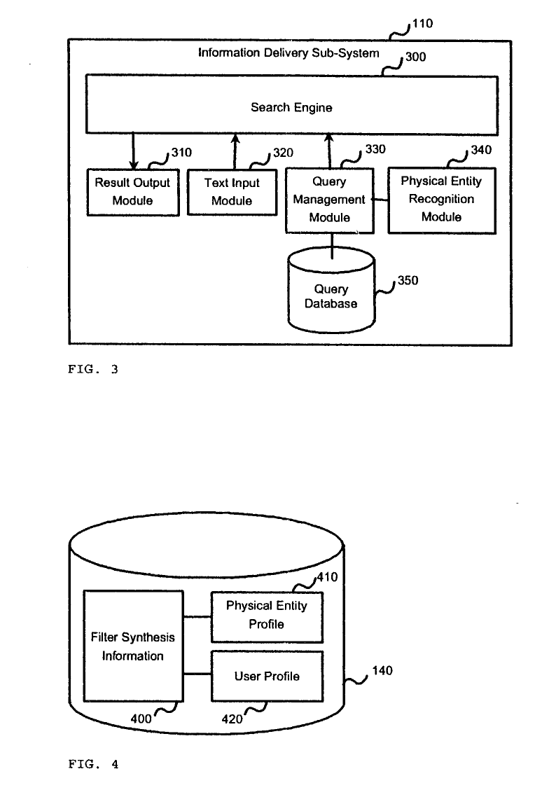

Architectures of the information delivery sub-system 110 are shown in FIG. 2 and FIG. 3. FIG. 2 and FIG. 3 show information delivery sub-systems 110 that provide an information filtering function and a profile-supported information retrieval function, respectively. The information delivery sub-system of either FIG. 2 or FIG. 3 can be used in the information delivery procedure control system in FIG. 1. Note that it is possible to configure said sub-system 110 so that the sub-system provides both said information filtering function and said profile-supported information retrieval function and allows users to select a function to use.

In the information filtering function of FIG. 2, first, information objects arrive at the information delivery sub-system 110 from information sources 100 on the network. The arrived information objects are sent to a filtering engine 200 and the filtering engine 200 applies the current filter to the sent information objects. The applied filter can be synthesized on demand using a filter synthesis module 120. It is also possible to synthesize the most recent filter in advance and store the synthesized filter in a memory area (not shown in the figure) of the information delivery sub-system considering efficiency of processing.

As a result of applying a filter, only the information objects that satisfy the condition of said filter are sent to a notification module. The notification module receives the information objects and delivers them to the user 160 based on the output condition of said filter. The output condition specifies timing, quantity, order, etc. for outputting information objects to users.

In an information dissemination function that selects relevant users from many users and disseminates information objects to selected users, it is necessary to efficiently apply a very large number of filters to an information object. However, as far as information delivery procedure control systems according to this invention are concerned, an architecture of the information dissemination function can be considered to be basically the same as the architecture of the information filtering function.

In the profile-supported information retrieval function of FIG. 3, the user 160 first inputs a query to the information delivery sub-system 110. Input methods for queries include a method that uses a text input module 320 and a method that uses a physical entity recognition module 340. In case queries are input using the text input module 320, users utilize a text input device such as a touch screen with pen input functionality or a keyboard to input queries using one of various query languages including a database query language, an information retrieval query language, and an XML query language. The input query is sent to a search engine 300. In case the physical entity recognition module 340 is used, the system recognizes a physical entity and then queries related to the recognized physical entity are retrieved in a query database 350. The retrieved queries are sent to the search engine. For example, when a customer presents a barcode of a commercial product at hand to a barcode scanner of the customer's own mobile device, the physical entity recognition module 340 acquires the barcode number of the commercial product as identifier information and sends said identifier information to a query management module 330. The query management module 330 retrieves queries associated with said identifier information using the query database 350 and then sends obtained queries to the search engine 300.

Here, the explanation was made using a barcode and a barcode scanner, however, besides these, a smart tag and a smart tag reader and various other sensors that are useful for identifying physical entities can be used. Of course, users can input identification information using a keyboard etc. if the identification information is displayed in a form that humans can understand. It goes without saying that location information can be used besides identifier information. That is, queries can be retrieved from the query database 350 using a physical space identified by a location sensor that involves the global positioning system (GPS). Hardware such as sensors can be exclusively provided for a physical entity recognition module 340. Alternatively, the physical entity recognition module 340 can share the hardware such as sensors that is provided for a physical filter recognition module 130.

Also, queries in the query database 350 are described using one of various query languages including a database query language, an information retrieval query language, and an XML query language. Furthermore, if multiple queries are retrieved from the query database, a query management module 330 either sends all queries to the search engine 300 or sends only the queries selected by users to the search engine 300.

The information search engine 300, after receiving queries, performs retrieval processing using said queries and the current filter. That is, first, the intersection of the result of said queries and the result of the query contained in the content of said filter is obtained via retrieval processing. The filter that will be used can be synthesized on demand using the filter synthesis module 120. Alternatively, the most recent filter can be synthesized in advance and stored in a memory area (not shown in the figure) of the information delivery sub-system 110 considering efficiency of processing.

The search engine 300 acquires information objects that are output as a result of retrieval processing from information sources 100 on the network and sends the acquired information objects to a result output module 310. The result output module 310, after receiving information objects, presents the information objects to the user 160 based on the output condition of said filter that specifies quantity, order, etc. of the information objects output to the user.

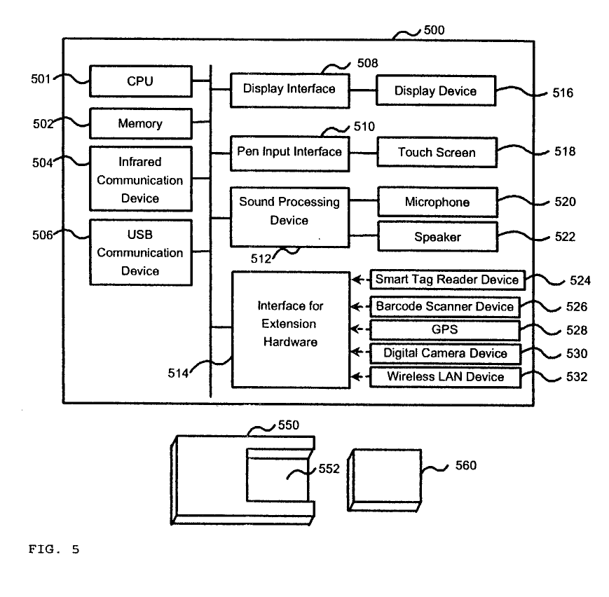

A structure of the profile database 140 is illustrated in FIG. 4. There are two kinds of profiles stored in the database: user profiles 420 and physical entity profiles 410. User profiles 420 are profiles that correspond to individual users and each user continuously uses each profile. Physical entity profiles 410 are profiles that correspond to physical entities recognized by the physical filter recognition module 130. Appropriate physical entity profiles 410 are used only when users present corresponding physical entities to the system. Note that using techniques such as social filtering can refine user profiles and physical entity profiles.

The contents of user profiles 420 and physical entity profiles 410 are described using queries. A database query language such as an SQL (Structured Query Language), a Boolean query form, and a vector space model form, etc. can be used as description forms of said queries. The user profiles 420 define output conditions besides queries. Timing for presenting users information objects that are obtained as a result of applying a filter (for example, presenting every time, presenting periodically, or presenting when a certain number of objects accumulate, etc. are specified), conditions on the quantity of information presented in one time, conditions on ordering and clustering for presenting multiple information objects, etc. are described as output conditions.

Filter synthesis information 400 references an user profile 420 and n (0=n) physical entity profiles 410 where n is the number of physical entities that are simultaneously recognized as filters by the filter recognition module. Queries defined in the n+1 profiles that are referenced by the filter synthesis information 400 are synthesized by n set operators where said n set operators can be a mix of various set operators including union operators, intersection operators and set difference operators. Responses of the queries defined in the profiles are n+1 sets of information objects. The correct output for a synthesized query is the set obtained by applying corresponding set operators to each set of the information objects. Note that the condition of the synthesized filter is the query synthesized according to the above description. Also, the output condition of the synthesized filter is the output condition of the user profile corresponding to said synthesized filter.

An exemplary architecture of a mobile device that users can use in an information delivery procedure control system according to this invention is illustrated in FIG. 5. Similar to regular computers, this mobile device 500 has a CPU (central processing unit) 501, a memory 502, and a display device 516. Text and image information generated by the CPU 501 is drawn on the display device 516 via a display interface 508. The display device 516 is combined with a touch screen 518 that reports to the CPU 501 via a pen input interface 510 when the user touches on the touch screen 518 with a pen or a finger. The user inputs characters and drawings on the mobile device 500 using a pen or a finger.

This mobile device 500 has a microphone 520 for recording sound and a speaker 522 for generating sound. The analog sound signals input by the microphone 520 is converted by a sound processing device 512 to digital signals that can be processed by the CPU 501. Furthermore, according to instructions by the CPU 501, digital signals are converted by the sound processing device 512 to analog sound signals which are generated from the speaker 522.

The main body 550 of this mobile device 500 is equipped with an insertion slot 552 where various kinds of hardware extension modules 560 can be attached to and detached from. The CPU 501 communicates with an attached hardware extension module via a hardware extension interface 514.

A smart tag reader device 524 is a type of hardware extension modules 560 that reads out information in smart tags located within a certain distance from this mobile device 500. Smart tags consist of microchips connected to small antennas where information can be stored in the microchips. The information stored in a smart tag is sent out to the smart tag reader device 524 according to a request from the smart tag reader device 524. Smart tags and the smart tag reader 524 communicate wirelessly using antennas. The mobile device 500 reads out identification information of the smart tag that is embedded in a nearby physical entity via the smart tag reader device 524 and thus identifies said physical entity.

A barcode scanner device 526 is a type of hardware extension modules 560 that reads out information printed as a barcode located within a certain distance from this mobile device 500. The barcode reader 526 reads barcode information that is printed on physical entities such as commercial products in a store and the physical entities are identified. Note that if existing barcodes that are printed on commercial products etc. are used, two different physical entities of the same product name are not distinguished. If it is necessary to distinguish these physical entities, it may be useful to supplement the barcode information with information provided by other ID sensors including smart tag readers, location sensors such as the GPS.

The GPS 528 is a type of hardware extension modules 560 that simultaneously receives signals from multiple GPS satellites and computes information about the current position. The mobile device 500 uses the computed information about the current position to recognize that said mobile device 500 exists within a specific physical area. Physical areas as well as physical objects are a specialized form of physical entities.

A digital camera device 530 is a type of hardware extension module 560 that provides freedom tocan take a picture of the areas around the mobile device. The photographed static images are stored in a memory 502 as digital information that can be processed by the CPU 501. It is possible to read identification information represented by a two-dimensional barcode attached on a physical entity such as a commercial product and identify the physical entity by taking a picture of the two dimensional barcode, storing the taken picture on the memory 502, and processing the picture by the CPU 501.

A wireless LAN device 532 is a type of hardware extension module 560 that allows for communication of information with other computers and mobile devices via a nearby base station. Identifying the station that the wireless LAN device 532 is using recognizes the fact that the mobile device currently exists within a specific physical area.

An infrared interface 504 allows for communication of information with other computers and mobile devices. The mobile device can communicate information with other nearby mobile devices via the infrared interface 504. In addition, the mobile device can communicate information with other computers and remote mobile devices via an infrared communication station.

USB (Universal Serial Bus) communication device 506 allows for communications with computers via connection cables. Connecting the mobile device and a computer using a USB connection cable allows for communications between the mobile device and the computer.

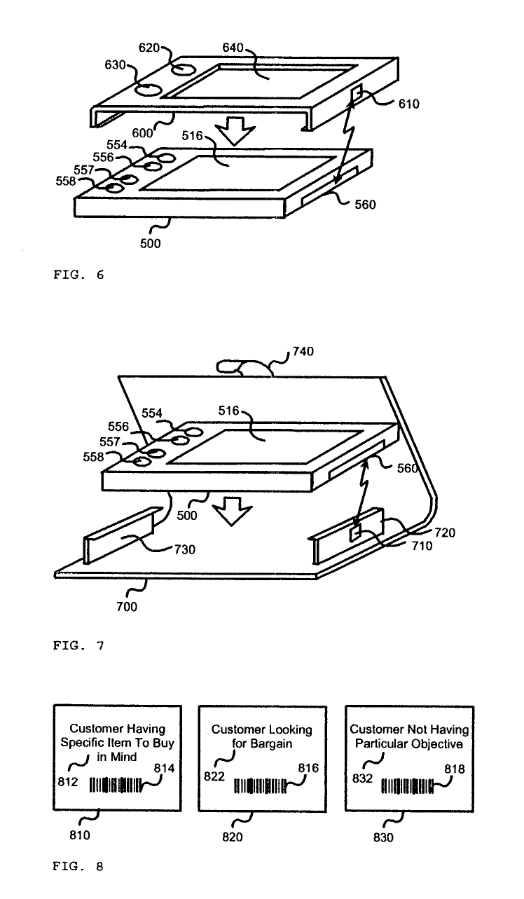

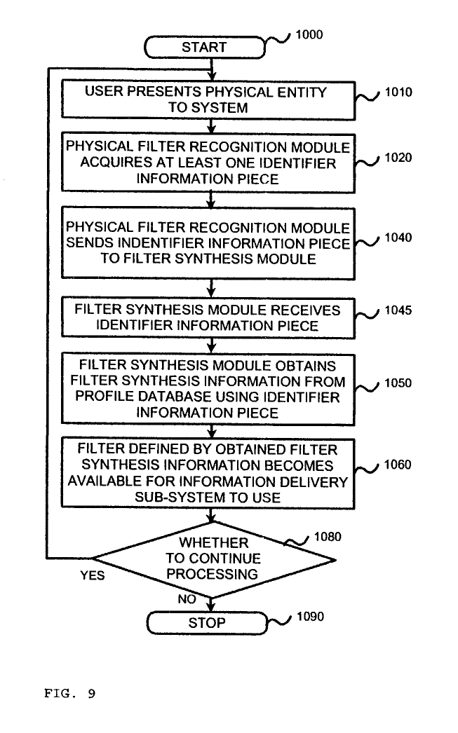

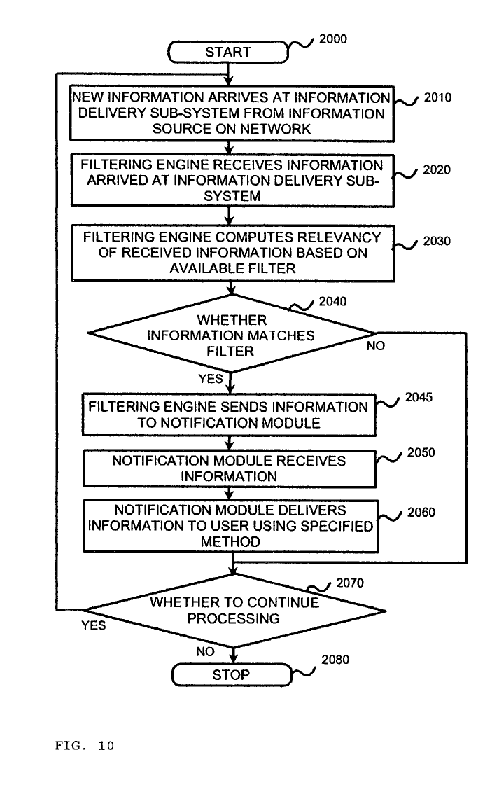

Exemplary physical entities that the physical filter recognition module 130 recognizes in the information delivery procedure control system according to this invention are illustrated in FIG. 6, FIG. 7 and FIG. 8.

In FIG. 6, the physical filter recognition module 130 recognizes a faceplate device 600 that can be attached to and detached from the mobile device 500. One and more than one faceplate device 600 is provided and the surface of each faceplate device 600 is decorated differently with various colors, patterns, pictures, texts, textures, etc. Therefore, users can easily distinguish each faceplate device and attach a favorite faceplate device that is selected according to the states of their minds, their objectives, etc. Also, when users press a button 620 or a button 630, one and more than one appropriate button from the buttons 554, 566, 557 and 558 of the mobile device 500 is pressed via mechanical workings. An opening 640 is provided so that a display device 516 and a touch screen 518 of the mobile device 500 can be used while the faceplate 600 is attached to the mobile device 500. The mobile device 500 can read identifier information embedded in the faceplate device 600 via electric contacts, physical contacts, or wireless communications. For example, a smart tag 610 on the faceplate device 600 can be read using wireless communications if a smart tag reader 524 is used as an extension module 560. Note that multiple smart tags can be read at the same time using an anti-collision function of a smart tag reader device. Suppose, for example, the faceplate device 600 in which a smart tag 610 is embedded is attached to the mobile device 500. The smart tag reader device 524 that is an extension module 560 supplies data acquired from the smart tag 610 to the physical filter recognition module 130. At the same time, said smart tag reader device can also acquire data from different smart tags, which is embedded in other physical entities, and supply said data to either the physical entity recognition module 340 or the physical filter recognition module 130.

In FIG. 7, the physical filter recognition module 130 recognizes a holder device 700 that can be attached to and detached from the mobile device 500. The backside of the mobile device 500 is contacted with the holder device 700 and a holding part 720 and a holding part 730 lock the mobile device. One and more than one holder device 700 is provided and the surface of each holder device 700 is decorated differently with various colors, patterns, pictures, texts, textures, etc. Therefore, users can easily distinguish each holder device 700 and use a favorite holder device that is selected according to the states of their minds, their objectives, etc. The mobile device 500 can read identifier information embedded in the holder device 700 via electric contacts, physical contacts, or wireless communications. For example, a smart tag 710 on the holder device 700 can be read using wireless communications if a smart tag reader 524 is used as an extension module 560. Note that multiple smart tags can be read at the same time using an anti-collision function of a smart tag reader device. Suppose, for example, the holder device 700 in which a smart tag 710 is embedded is attached to the mobile device 500. The smart tag reader device 524 that is an extension module 560 supplies data acquired from the smart tag 710 to the physical filter recognition module 130. At the same time, said smart tag reader device can also acquire data from different smart tags, which is embedded in other physical entities, and supply said data to either the physical entity recognition module 340 or the physical filter recognition module 130. Therefore, it is easy to attach both the faceplate device 600 and the holder device 700 and use them at the same time. Note that, in FIG. 7, the holding part 720 and the holding part 730 are provided so that they lock the head and the bottom sides of the mobile device 500. However, the holding parts can alternatively be provided so that they lock the left and the right sides of the mobile device. If the left and the right sides are locked, the smart tag 710 can be embedded in a different appropriate part of the holder device 700 so that the smart tag can communicate with the smart tag reading device 524 easily.

The physical filter recognition module 130 recognizes a filter card 810, a filter card 820 and a filter card 830 in FIG. 8. The barcode scanner 526 of the mobile device 500 can read a barcode 814, a barcode 816 and a barcode 818 that are printed on individual filter cards. Memory aid information 812, memory aid information 822 and memory aid information 832 are information printed on filter cards so that users can easily recognize and select each filter card. Besides texts, various forms of information including pictures and icons can be used as memory aid information.

An example of a procedure for synthesizing a filter using an intuitive operation according to this invention is explained using FIG. 9. Processing begins in step 1000 and continues to step 1010. In step 1010, a user presents at least one physical entity to the system and processing continues to step 1020. Next, in step 1020, the physical filter recognition module 130 acquires at least one identifier information piece of the presented physical entity using sensors etc. and processing continues to step 1040. In step 1040, the physical filter recognition module 130 sends said identifier information piece to the filter synthesis module 120 and processing continues to 1045. In step 1045, the filter synthesis module 120 receives the identifier information piece and processing continues to step 1050. In step 1050, the filter synthesis module 120 uses the received identifier information piece to search the profile database 140 and obtain filter synthesis information 400 for a filter that is synthesized from relevant physical entity profiles 410 and user profiles 420 and processing continues to step 1060. In step 1060, a filter that is defined by the obtained filter synthesis information 400 becomes available for use by the information delivery sub-system and processing continues to step 1080. Here, it is possible to store the obtained filter synthesis information in the information delivery sub-system for efficient processing. In step 1080, a determination is made as to whether to continue processing further. If continuing is not desired processing continues to step 1090 where the processing sequence ends. Otherwise, processing returns to step 1010.

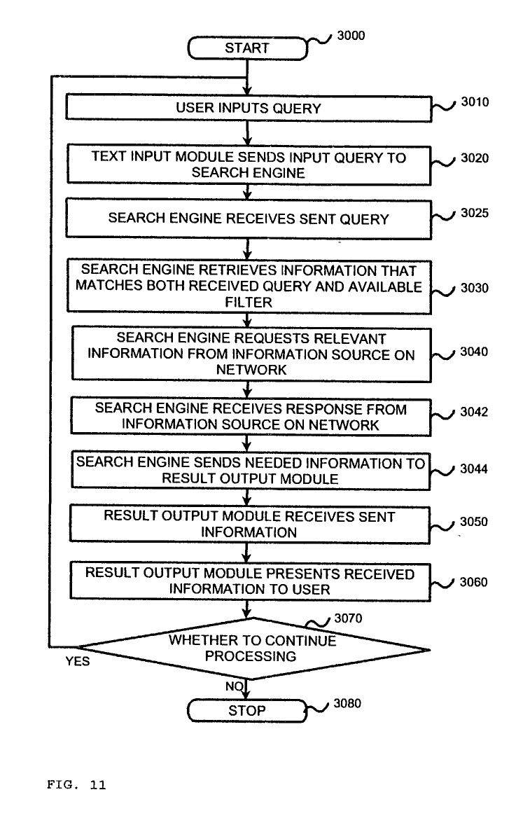

Next, an example of a procedure for controlling information delivery procedures, specifically, controlling an information filtering function according to this invention is explained using FIG. 10. Processing begins in step 2000 and continues to step 2010. In step 2010, a new information object arrives at the information delivery sub-system 110 from information sources 100 on the network and processing continues to step 2020. In step 2020, the filtering engine 200 receives said information object that arrived at the information delivery sub-system 110 and processing continues to step 2030. In step 2030, the filtering engine 200 computes the relevancy of said received information object based on filters that are currently available for users to use and processing continues to step 2040. In step 2040, a determination is made as to whether said information object is relevant to said available filters. If it is relevant, processing continues to step 2045. Otherwise, processing jumps to step 2070. In step 2045, the filtering engine 200 sends said information object to the notification module 210 and processing continues to step 2050. In step 2050, the notification module 210 receives said information object and processing continues to step 2060. In step 2060, the notification module 210 delivers said information object to the users using methods that are specified in the filter output conditions of said available filters and processing continues to step 2070. In step 2070, a determination is made as to whether to continue processing further. If continuing is not desired processing continues to step 2080 where the processing sequence ends. Otherwise, processing returns to step 2010.

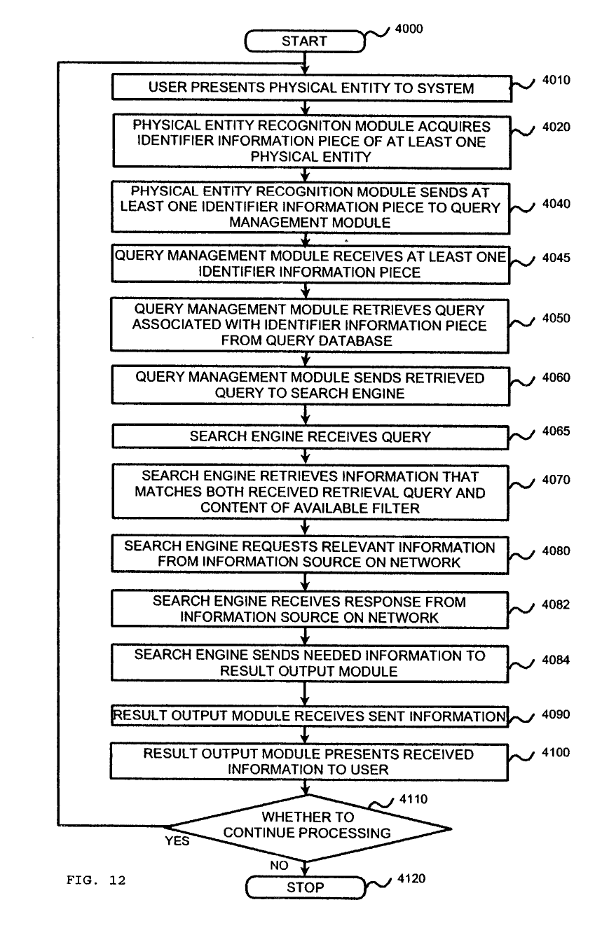

Next, an example of a procedure for controlling information delivery procedures, specifically, controlling an information retrieval function using the text input module 320 according to this invention is explained using FIG. 11. Processing begins in step 3000 and continues to step 3010. In step 3010, a user inputs a query using the text input module 320 and processing continues to step 3020. In step 3020, the text input module 320 sends said input query to the search engine 300 and processing continues to 3025. In step 3025, the search engine 300 receives said query and processing continues to step 3030. In step 3030, the search engine 300 retrieves information objects that satisfy both the condition of the currently available filter and the condition of said received query and processing continues to step 3040. In step 3040, the search engine 300 requests relevant information from information sources 100 on the network before outputting the information objects that are obtained as the result of the retrieval and processing continues to step 3042. In step 3042, the search engine 300 receives responses from information sources 100 on the network and processing continues to step 3044. In step 3044, the search engine 300 sends said information objects and said received responses to the result output module 310 and processing continues to step 3050. In step 3050, the result output module 310 receives said sent information objects and said responses and processing continues to step 3060. In step 3060, the result output module 310 presents said information objects and said responses to the user based on the output condition defined by said filter and processing continues to step 3070. In step 3070, a determination is made as to whether to continue processing further. If continuing is not desired, processing continues to step 3080 where the processing sequence ends. Otherwise, processing returns to 3010.

Next, an example of a procedure for controlling information delivery procedures, specifically, controlling an information retrieval function using the physical entity recognition module 340 is explained using FIG. 12. Processing begins in step 4000 and continues to step 4010. In step 4010, a user presents at least one physical entity to the system and processing continues to step 4020. In step 4020, the physical entity recognition module 340 acquires identifier information of at least one physical entity and processing continues to step 4040. In step 4040, the physical entity recognition module 340 sends at least one identifier information piece to the query management module 330 and processing continues to step 4045. In step 4045, the query management module 330 receives said sent identifier information piece and processing continues to step 4050. In step 4050, queries that correspond to said received identifier information piece is retrieved from the query database 350 and processing continues to step 4060. In step 4060, the query management module 330 sends said retrieved queries to the search engine 300 and processing continues to step 4065. In step 4065, the search engine 300 receives said sent queries and processing continues to step 4070. In step 4070, the search engine 300 retrieves information objects that satisfy both the condition of the filter that is currently available for the user to use and the conditions of said queries and processing continues to step 4080. In step 4080, the search engine 300 requests relevant information from information sources 100 on the network before outputting the information objects obtained as the result of the retrieval to the user and processing continues to step 4082. In step 4082, the search engine 300 receives responses from information sources 100 on the network and processing continues to step 4084. In step 4084, the search engine 300 sends said information objects and said received responses to the result output module 310 and processing continues to step 4090. In step 4090, the result output module 310 receives said sent information objects and said responses and processing continues to step 4100. In step 4100, the result output module 310 presents said received information objects and said responses to the user based on the output condition defined by said filter and processing continues to step 4110. In step 4110, a determination is made as to whether to continue processing further. If continuing is not desired, processing continues to step 4120 where the processing sequence ends. Otherwise, processing returns to step 4010.

Effect of Invention

The systems and the methods according to this invention, unlike existing systems that do not allow for controlling information delivery procedures using physical entities, can control information delivery systems through intuitive operations using physical entities and allow users to obtain information that is relevant to their new interests when the users' interests change abruptly. In particular, the systems and the methods according to this invention allow novice as well as regular users who do not have knowledge about the internal model of the systems to perform the operation of selecting profiles and the operation of synthesizing filters quickly and tangibly through intuitive operations using physical entities. The systems and the methods according to this invention are expected to be effective when users use mobile devices because they are used in various situations and display screens and input methods of mobile devices are limited. When users use devices except for mobile devices for obtaining information, it can be expected that the systems and the methods according to this invention allows users to obtain better information using a simple operation.

What is claimed is:

1. An information delivery procedure control system that is capable of recognizing at least one physical entity and controlling information delivery procedures by using filters that are synthesized according to said physical entity comprising:
a physical entity recognition procedure that recognizes a physical entity and obtains information that is sufficient for identifying the physical entity;
a filter synthesis procedure that synthesizes a filter by using obtained identification information of a physical entity;
an information delivery procedure that delivers information according to the description of said synthesized filter; and
a profile management procedure that stores and manages profile information that is utilized when said filter synthesis procedure synthesizes a filter.

2. The system of claim 1 wherein information is delivered to users using at least one of an information filtering function, a profile-supported information retrieval function, and an information dissemination function.

3. The system of claim 1 wherein said profile-supported retrieval function allows users to create queries using at least one of a database query language, an information retrieval query language and an extensible markup language (XML) query language.

4. The system of claim 1 wherein said profile-supported retrieval function allows for creating queries using identification information of physical entities.

5. The system of claim 1 wherein said filter synthesis procedure synthesizes filters using user profiles and physical entity profiles.

6. The system of claim 1 wherein said filter synthesis procedure synthesizes filters using at least one of an on-demand synthesis procedure for synthesizing filters every time when said information delivery procedure demands and an advance synthesis procedure that synthesizes filters when said physical entity recognition procedure recognizes a physical entity and stores the synthesized filters in preparation for future demands from said information delivery procedure.

7. The system of claim 1 wherein said physical entity recognition procedure utilizes at least one of a barcode scanner, a radio frequency identification (RFID) reader, a scanner, an infrared signal reader, a client device of an embedded Web server, an electromagnetic induction sensor, an electrostatic induction sensor, a ultrasound sensor, a microchip reader, a magnetic card reader, a biometrics information reader, an image recognition device, the global positioning system (GPS), a device that identifies a service area using access points of wireless communications, a real time locating system (RTLS), and a manual input procedure of identification information.

8. The system of claim 1 wherein identification information of a physical entity is provided to said physical entity recognition procedure using at least one of a faceplate device, a holder device and a filter card.

9. An information delivery procedure control method that allows users to control information delivery procedures using physical entities comprising:
presenting to a device that is able to compute such as a mobile device andor a computer a physical entity with which at least one filter is associated;
recognizing said presented physical entity and obtaining sufficient information for identifying the physical entity;
synthesizing a filter using said obtained identification information;
delivering information according to the description of said synthesized filter; and
storing and managing profile information used for synthesizing said filter.

10. The method of claim 9 wherein information is delivered to users using at least one of an information filtering procedure, a profile-supported information retrieval procedure, and an information dissemination procedure when information is delivered to users according to the description of said filter.

11. The method of claim 9 wherein users create queries using at least one of a database query language, an information retrieval query language and an extensible markup language (XML) query language when performing said profile-supported information retrieval.

12. The method of claim 9 wherein queries are created using identification information of physical entities when performing said profile-supported information retrieval.

13. The method of claim 9 wherein filters are synthesized using user profiles and physical entity profiles when performing said synthesis of a filter.

14. The method of claim 9 wherein at least one of the procedure that synthesizes filters every time when information is delivered to users and the procedure that synthesizes filters when a physical entity is recognized and stores said synthesized filters in preparation for future demands of information delivery is used when performing said synthesis of a filter.

15. The method of claim 9 wherein at least one of a barcode scanner, a radio frequency identification (RFID) reader, a scanner, an infrared signal reader, a client device of an embedded Web server, an electromagnetic induction sensor, an electrostatic induction sensor, a ultrasound sensor, a microchip reader, a magnetic card reader, a biometrics information reader, an image recognition device, the global positioning system (GPS), a device that identifies a service area using access points of wireless communications, a real time locating system (RTLS), and a manual input procedure of identification information is used when performing said recognition of a physical entity.

16. The method of claim 9 wherein identification information of a physical entity is provided using at least one of a faceplate device, a holder device and a filter card when performing said recognition of a physical entity.
